(19) United States
(12) Patent Application Publication
(10) Pub. No.: US 2012/0237671 A1
(43) Pub. Date: Sep. 20, 2012

(54) METHOD AND ARRANGEMENT FOR APPLICATION OF ELECTRICALLY CONDUCTIVE LAYERS WITH A HIGH CURRENT CARRYING CAPABILITY FOR MAKING INTERNAL CONTACT WITH CHANNELS

(75) Inventors: Friedhelm Tupaika, Waltersdorf (DE); Joerg-Ray Sikora, Jena (DE); Stephanie Esefeld, Langenschade (DE)

(73) Assignee: Fraunhofer Gesellschaft zur Foerderung der angewandten Forschung, e.V., Munich (DE)

(21) Appl. No.: 13/512,915

(22) PCT Filed: Dec. 1, 2010
(86) PCT No.: PCT/DE2010/050087

§ 371 Date: May 31, 2012

(30) Foreign Application Priority Data
Dec. 3, 2009 (DE) 10 2009 057 289.9

(51) Int. Cl. B05D 5/12; B05C 3/09

(52) U.S. Cl. 427/123; 118/400; 118/429

(57) ABSTRACT

A method applies layers to channels of a resistance heating element, where the channels are arranged in a honeycomb structure and receive a medium to be heated. Adjacent layers communicate with electrically conducting end-face metallizations of the resistance heating element and have, at an opposite end, an insulation region in relation to another respective end-face metallization. To apply the layers, a miniature lance is immersed into the channel to be coated. The miniature lance is hollow, closed at a lower end, has an upper end communicating with a reservoir of metal paste, and includes outlets in a lower region that are directed to inner walls. Metal paste is uniformly applied to the inner walls of the channel by pressure while simultaneously moving the miniature lance. The miniature lance is inserted into an adjacent channel for coating inner walls of the adjacent channel from the other end-face metallization side.

### CROSS REFERENCE TO RELATED APPLICATIONS

This application is a U.S. National Phase application under 35 U.S.C. §371 of International Application No. PCT/DE2010/050087, filed on Dec. 1, 2010, and claims benefit to German Patent Application No. DE 10 2009 057 289.9, filed on Dec. 3, 2009. The International Application was published in German on Jun. 9, 2011 as WO 2011/066826 A1 under PCT Article 21 (2).

### FIELD

The invention is directed to a method and an arrangement suitable for implementing the method for making internal contact in channels of resistance heating elements.

### BACKGROUND

Resistance heating elements including channels are generically described in DE 100 60 301 A1. The operation of resistance heaters at vehicle voltages (12/24V) in the automotive field (passenger cars, utility vehicles, caravans, boats, etc.) at relevant heat outputs of around 1 kW compulsorily results in currents of up to 100 A and even higher currents at start-up of commonly used PTC heaters. In order to achieve the durable electrical contacts demanded in PTC ceramics, high requirements are imposed with respect to electrical conductivity and the geometric arrangement of metallic contact layers. Heating elements with PTC components (e.g., 28×6×1.5 mm3) or smaller-capacity auxiliary heaters having a honeycomb structure are commonly used for heating the passenger compartment of passenger cars. In both cases, depending on electrical output, metallic layers having sufficient current carrying capacity (cross section) are applied. The layers are preferably printed (thick film technology) or sputtered.

Further development of PTC honeycomb heaters according to DE 100 60 301 A1 requires that the inner walls of the channels must be metallically coated according to a predetermined pattern. The layers must similarly ensure the above-described features for current carrying capacity and long-lasting functional reliability. The program for coating the channels must be carried out in such a way that the inner contacts are alternately connected to one front-side metallization and not connected to the other, opposite metallization. Two different technologies are known for this purpose. First, the electrical insulation section is realized through subsequent mechanical removal of the metallic layer (U.S. Pat. No. 4,107,515). This step is cumbersome because the layer must be removed with absolute reliability due to the danger of short circuits. It is necessary to use diamond tools (ceramic) which are only suitable to a limited extent for the metal layer (ductile). Moreover, in case of a square or rectangular channel cross section, a problem results in channel corners (tool radius, channel corner radius). The expenditure does not appear to be economically feasible for series production.

Alternatively, the insulating regions are covered before the channels are completely metallized and must then be eliminated again after the contact layers are burned in. This technology is also very time-consuming.

### SUMMARY

In an embodiment, the present invention provides a method for applying electrically conducting layers having high current carrying capacity to walls of channels of an electric resistance heating element, where the channels are arranged in a honeycomb structure and are configured to receive a medium to be heated flowing therethrough. Adjacent electrically conducting layers mutually communicate with electrically conducting end-face metallizations of the resistance heating element and have, respectively, at an opposite end, an insulation region in relation to another respective end-face metallization. To apply the layers, a miniature lance is immersed into a channel to be coated. The miniature lance corresponds to an inner shape of the channel with a cross section that is smaller than a cross section of the channel by at least a thickness of the layer to be applied. The miniature lance is also hollow, closed at a lower end, has an upper end communicating with a reservoir filled with a metal paste, and includes outlets in a lower region that are directed to inner walls of the channel. Metal paste is uniformly applied to the inner walls of the channel by pressure through the outlets while simultaneously moving the miniature lance.

### BRIEF DESCRIPTION OF DRAWINGS

Exemplary embodiments of the present invention will be described in more detail in the following with reference to the drawings, in which:

FIG. 1 is a schematic perspective view of a miniature lance according to the invention;

FIG. 2 is a schematic perspective view of four miniature lances arranged together in a row;

FIG. 3 is a sectional view through the stock distribution vessel; and

FIG. 4 is a schematic perspective view of a honeycomb body.

### DETAILED DESCRIPTION

In an embodiment, the present invention makes it possible to metallically coat the inner walls of the channels of a honeycomb-type heater according to a predetermined pattern quickly and precisely while avoiding the disadvantages of the prior art.

In an embodiment, the present invention provides a method for applying electrically conducting layers having a high current carrying capacity to the walls of channels of an electric resistance heating element, a medium which is to be heated flowing through these channels, wherein the channels are arranged as a honeycomb structure, and adjacent electrically conducting layers mutually communicate with the electrically conducting end-face metallizations of the resistance heating element and have, respectively, at the other end an insulation region in relation to the other respective end-face metallization, wherein
a miniature lance is immersed in the channel to be coated, wherein the miniature lance
corresponds to the inner shape of the channels but is smaller in cross section at least by the thickness of the layer to be applied,
is hollow,
is closed at the lower end,
communicates at the upper end with a reservoir which is filled with a metal paste, and
further, has outlets in the lower region which are directed to the inner walls of the channels,
the metal paste is uniformly applied to the inner walls of the channels by means of pressure through the outlets while the miniature lance moves out simultaneously, and
in case of adjacent channels, the miniature lance is immersed in the channel for coating proceeding from the other end-face metallization side.

The width of the insulation region can advantageously be changed either by immersing the miniature lance less deeply into the channel or by using miniature lances having outlets having different distances viewed from the end.

In order to prevent the metal paste that has already been applied from possibly running during the drying process, it has proven advantageous to rotate the honeycomb body around an axis extending parallel to the channels.

In an embodiment, the present invention also provides an arrangement for applying electrically conducting layers having a high current carrying capacity to the walls of channels of an electric resistance heating element, a medium which is to be heated flowing through these channels, wherein the channels are arranged as a honeycomb structure, and adjacent electrically conducting layers mutually communicate with the electrically conducting end-face metallizations of the resistance heating element and have, respectively, at the other end an insulation region in relation to the other respective end-face metallization, characterized in that the arrangement includes a miniature lance, wherein the latter
corresponds to the inner shape of the channels but is smaller in cross section at least by the thickness of the layer to be applied,
is hollow,
is closed at the lower end,
communicates at the upper end with a reservoir which is filled with a metal paste, and
further, has outlets in the lower region which are directed to the inner walls of the channels.

To further reduce the coating time for all channels, it is particularly advantageous to arrange a plurality of miniature lances, either in rows or matrix form, in such a way that when the collected miniature lances are inserted into the channels one channel remains open between each two adjacent miniature lances. In this regard, all of the miniature lances are associated with a stock distribution vessel so that the metal paste issuing from the reservoir under corresponding pressure is uniformly distributed to the cavities of the respective miniature lances in order to guarantee in turn a uniform distribution through the outlets. Since the geometries of the honeycomb bodies are subject to certain tolerances, it is advantageous when the miniature lances communicate flexibly with the stock distribution vessel.

Without limiting thereto, the resistance heating elements comprise resistance material with a positive temperature coefficient of resistance (PTC resistance).

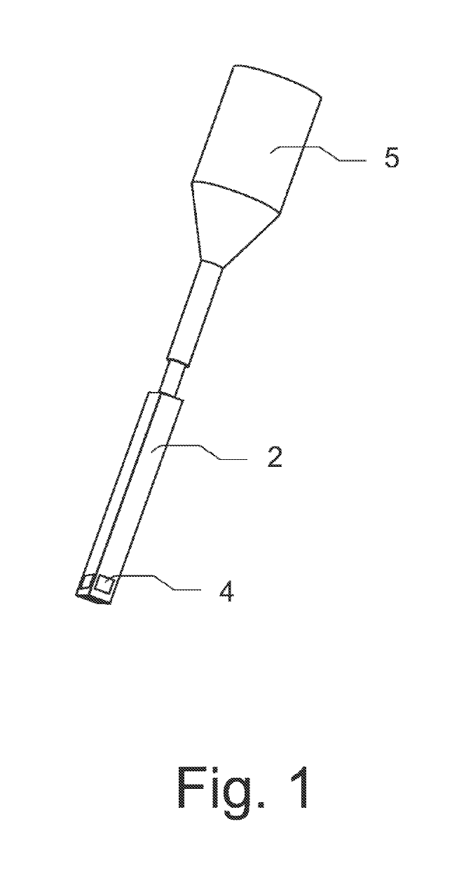

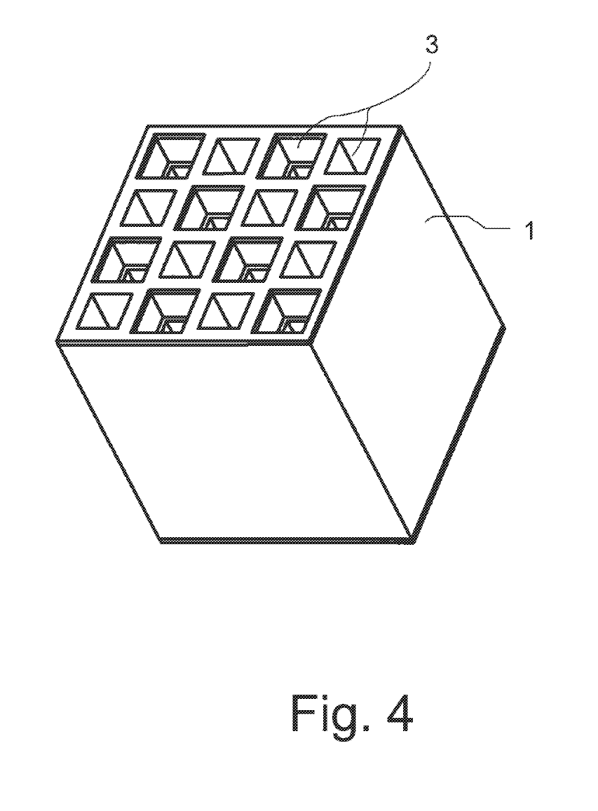

A honeycomb body 1, shown in FIG. 4, is placed upon a flat substrate. The coating tool, in this instance, according to FIG. 1, an individual miniature lance 2, is inserted until bottoming out in a first channel 3 to be coated. The position of the outlets 4 of the miniature lance 2 accordingly determines the width of the insulation regions for front-side metallization of the counter-electrode.

The inside coating can now take place using a commercially available metering device. The reservoir 5, which is filled with a suitable metal paste, directly communicates with the miniature lance 2. The reservoir 5 is acted upon by a defined pressure so that a corresponding amount of metal paste is applied to the inner walls of the channel 3 through the outlets 4.

Simultaneous with the dispensing of the metal paste, the miniature lance 2 is pulled out of the channel 3 at a defined constant speed. During this process, the paste is uniformly distributed at the inner surfaces of the channels 3.

This process is repeated until every second channel 3 is provided with the metal paste.

After the coating process, the applied paste is dried in a heated unit. For this purpose, the honeycomb body 1 is clamped into a device which keeps it constantly in motion during the drying process so that the paste does not collect in the corners of the channels or run over the insulation edge. In so doing, the honeycomb body 1 is preferably rotated around an axis extending parallel to the axes of the channels 3.

After the drying process, all of the above-described steps are carried out on the second honeycomb side so that a mutual inside coating takes place.

Prior to or subsequent to producing internal contact, the front sides of the honeycomb are likewise metallized with a suitable metal paste.

After coating the front sides and inner sides of the honeycomb body 1, contacts suitable for supplying current are arranged at the side surfaces of the honeycomb which are electrically connected to the corresponding front surfaces of the honeycomb body 1 and have a corresponding current carrying capacity.

The applied metal structures are burned in, either after each of the metallizing and drying steps mentioned above or after metallization and drying have been completely carried out, in a burning process as specified by the particular paste manufacturer.

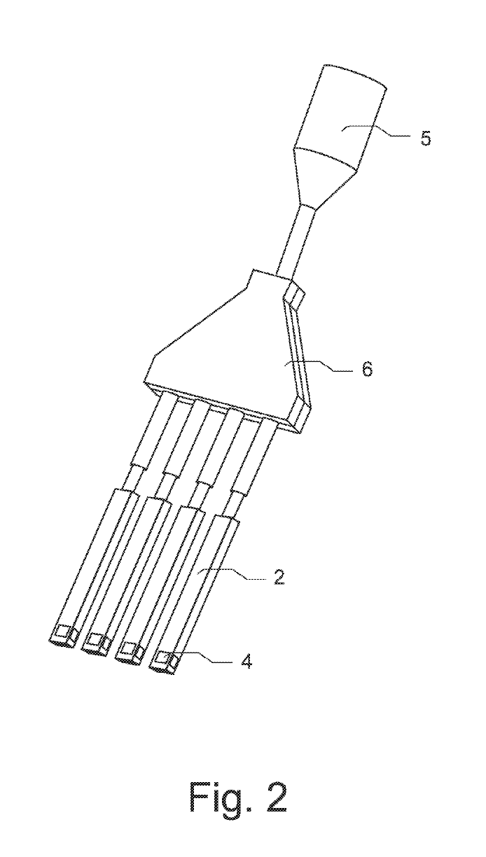

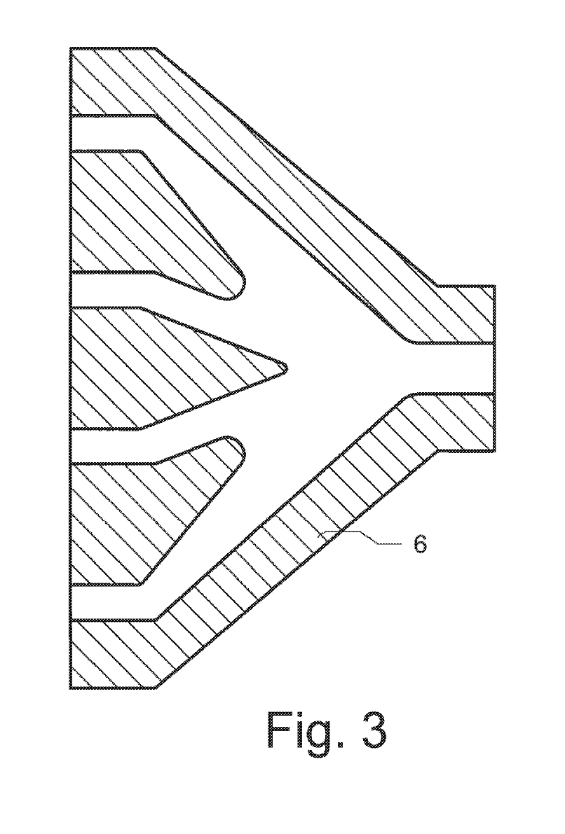

Another embodiment of a coating tool is shown in FIG. 2. In this case, four miniature lances 2 were arranged together at a stock distribution vessel 6. In the inserted stated, there is always present between two channels 3 in which the miniature lances 2 are inserted a free channel 3 which is not coated until the second step, likewise in groups starting from the other side. FIG. 3 shows a section through the stock distribution vessel 6. The distribution is especially important because the paste which is supplied from the reservoir 5 under a determined pressure should be guided into the individual miniature lances 2 uniformly. In other conceivable embodiments, the miniature lances 2 are associated in matrix form with a correspondingly configured stock distribution vessel 6.

Further, the miniature lances 2 can be flexibly connected to the stock distribution vessel 6 making it possible to compensate for possible tolerances in the geometry of a honeycomb body 1. Generally speaking, it should be noted that the stock distribution vessel 6 and/or the reservoir 5 can, of course, also be arranged farther apart spatially relative to the miniature lances, e.g., by means of tube connections.

While the invention has been particularly shown and described with reference to preferred embodiments thereof, it will be understood by those skilled in the art that various changes in form and details may be made therein without departing from the spirit and scope of the invention.

### LIST OF REFERENCE NUMERALS

1 honeycomb body

2 miniature lance

3 channel

4 outlets

5 reservoir

6 stock distribution vessel

1-7. (canceled)

8. A method for applying electrically conducting layers having high current carrying capacity to walls of channels of an electric resistance heating element, the channels being configured to receive a medium to be heated flowing therethrough and being arranged in a honeycomb structure, and adjacent electrically conducting layers mutually communicating with electrically conducting end-face metallizations of the resistance heating element and having, respectively, at an opposite end, an insulation region in relation to another respective end-face metallization, the method comprising:
immersing a miniature lance into a channel to be coated, the miniature lance corresponding to an inner shape of the channel with a cross section that is smaller than a cross section of the channel by at least a thickness of the layer to be applied, the miniature lance being hollow, closed at a lower end, having an upper end communicating with a reservoir filled with a metal paste, and including outlets in a lower region that are directed to inner walls of the channel; and
uniformly applying metal paste to the inner walls of the channel by pressure through the outlets while simultaneously moving the miniature lance.

9. The method recited in claim 8, further comprising immersing the miniature lance into an adjacent channel for coating inner walls of the adjacent channel from the other end-face metallization side.

10. The method recited in claim 8, further comprising increasing a width of the insulation region by reducing a depth to which the miniature lance is immersed in the channel.

11. The method recited in claim 8, further comprising rotating the resistance heating element around an axis parallel to the channels during a hardening process of the metal paste.

12. An arrangement for applying electrically conducting layers having high current carrying capacity to walls of channels of an electric resistance heating element, the channels being configured to receive a medium to be heated flowing therethrough and being arranged in a honeycomb structure, and adjacent electrically conducting layers mutually communicating with electrically conducting end-face metallizations of the resistance heating element and having, respectively, at an opposite end, an insulation region in relation to another respective end-face metallization, the arrangement comprising:
a first miniature lance corresponding to an inner shape of a channel with a cross section that is smaller than a cross section of the channel by at least a thickness of the layer to be applied, the miniature lance being hollow, closed at a lower end, having an upper end communicating with a reservoir filled with a metal paste, and including outlets in a lower region that are directed to inner walls of the channel.

13. The arrangement recited in claim 12, wherein a distance between the lower end of the first miniature lance and the outlet corresponds to a width of the insulation region of the channel.

14. The arrangement recited in claim 12, further comprising additional miniature lances so as to form, with the first miniature lance, a plurality of miniature lances arranged in a row or matrix and positioned so as to be inserted into channels of the resistance heating element with an open channel disposed between each two adjacent miniature lances,
wherein the plurality of miniature lances are associated with a stock distribution vessel configured to uniformly distribute metal paste from the reservoir to cavities of the plurality of miniature lances.

15. The arrangement recited in claim 14, wherein the plurality of miniature lances are flexibly associated with the stock distribution vessel so as to compensate for geometric tolerances of the honeycomb structure.
